(19) United States
(12) Patent Application Publication
(10) Pub. No.: US 2008/0187155 A1
(43) Pub. Date: Aug. 7, 2008

(54) Surround sound system in a tower enclosure

(76) Inventor: Jason Hou, Covina, CA (US)

Correspondence Address: Myers Dawes Andras & Sherman LLP, Suite 1150, 19900 MacArthur Blvd., Irvine, CA, 92612, US

(21) Appl. No.: 12/012,104

(22) Filed: Jan. 31, 2008

Related U.S. Application Data
(60) Provisional application No. 60/898,962, filed on Feb. 1, 2007.

(51) Int. Cl. H04R 5/02

(52) U.S. Cl. 381/300

(57) ABSTRACT

A surround sound system includes a vertically elongated housing, a plurality of speakers arranged substantially vertically inside the housing, and one or more audio signal sources for outputting audio signals in multiple channels to the plurality of speakers. The multiple channels and speakers can be configured as a 5.1 system. The one or more audio signal sources may include a fixed media player embedded substantially within the housing, and a portable media player removably docked to the housing. A radio signal tuner and antenna are also included in the surround sound system and enclosed in the housing. The surround sound system may further include a Karaoke mixer and be used as a Karaoke performance machine.

### RELATED APPLICATIONS

This application relates to, claims priority from, and incorporates herein by reference, as if fully set forth, U.S. Provisional Patent Application Ser. No. 60/898,962, filed on Feb. 1, 2007 and entitled “All-in-one surround sound enclosure with multiple functionalities.”

### BACKGROUND OF THE INVENTION

1. Field of the Invention

The present invention relates generally to sound systems and particularly to surround sound systems.

2. Description of Prior Art and Related Information

The earliest sound reproduction systems have a single sound source, such as a horn speaker or a transducer, emitting a localized, monophonic sound wave. Stereophonic systems were later developed using two speakers to reproduce delocalized sound waves such that listeners can perceive directionality of sounds, for example, from the left or right. The two sound fields give the listener an impression closer to the realities as compared to a monophonic sound field. However, the stereophonic system is still a simplified simulation of real sound fields, which typically contain sound waves from multiple sources located at multiple positions in space relative to the listener.

Consumers are continually seeking to replicate the theater experience in their homes with newer televisions, media players, and particularly newer surround sound systems. Multi-channel surround sound is becoming common in audiovisual systems. Unlike conventional stereophonic sound systems, the newer surround sound techniques intentionally modify the sound waves or sound field, and allow the sound field to be dynamically shifted, for example, to the sides of and behind the listener, and from a variety of directions. By coordinating the screen display with shifting sound propagation around the room, the sound associated with motion pictures can develop a greater realism.

Multi-channel sound reproduction systems employ one or more surround-sound channels, in additional to left and right channels of conventional stereophonic sound systems. A driving force behind the widespread use of the multi-channel surround systems is the availability to consumers the DVDs, high-definition DVDs (HD DVDs), Blu-ray Discs, compact discs (CDs), high-definition TVs (HDTVs), direct TVs, broadcast or cable TVs, etc. Adding these to surround sound systems, consumers can now stay home while enjoying movies, music, and games with realistic sound effect comparable to that in a theatre

The different channels cover a large range of sound spectrum, and are fed into different speakers or transducers accordingly. For example, tweeters cover high-frequency ranges, from which a listener readily perceives a sound source or orientation. Woofers or subwoofers cover the low-frequency ranges with less directionality. Mid-frequency-range speakers are also typically included in the sound systems.

To reproduce sound field as if from a plurality of sound sources from different directions, conventional systems employ multiple speakers dispersed at multiple predetermined positions in a room. Complex circuitry is needed to synchronize sounds from the different speaker devices, and speaker cables are needed to couple the amplifier to each of these speakers. For hi-fi playback, the speaker cables should be as short as possible. For discrete speakers that are placed apart from each other at a significant distance, loss along the cables becomes an issue. However, this adds complexity to the home entertainment system 201. In addition, the discrete speakers are often difficult to arrange in a home, especially a room of a relatively small size.

FIGS. 1 and 2 show a conventional surround sound system 100. As shown in FIG. 1, the surround sound system 100 includes a plurality of speakers, including left surround sound speaker 102, left speaker 104, center speaker 105, right speaker 106, and right surround sound speaker 108, each input with a separate sound channel from a sound control system (not shown). These speakers are spread horizontally, and are essentially all pointing to the listener or listening position 110.

As shown in FIG. 2, the conventional surround sound system 100 is usually located below a screen or display 200 of a home entertainment or theatre system 201. Separate audiovisual signal sources, such as VCR or DVD players, provide signal input to the sound system 100 and the display 200. Sound wave 202 travels substantially horizontally toward the listener or listening position 110. In some systems, additional rear speakers (not shown) are placed behind the listener 110 for rear channel reproduction. An additional subwoofer (not shown) may be included in the system for low-frequency portion of the audio signal.

### SUMMARY OF THE INVENTION

In one aspect, the present invention provides a surround sound system, including a vertically elongated housing, a plurality of speakers arranged substantially vertically inside the housing, and one or more audio signal sources for outputting audio signals in multiple channels to the plurality of speakers.

In one embodiment, the vertically elongated housing has a ratio between its height and width in the range of 2 to 10. In a preferred embodiment, the ratio is in the range of 4 to 6.

The plurality of speakers may include a left surround speaker, a right surround speaker, a first left front speaker, a first right front speaker, a center speaker, and a subwoofer. The system may further include a second left front speaker, wherein the second left front speaker and the first left front speaker receive audio signals from the same channel, and wherein the second left front speaker and the first left front speaker are disposed at substantially orthogonal directions. In one embodiment, the system further includes a second right front speaker, wherein the second right front speaker and the first right front speaker receive audio signals from the same channel, and wherein the second right front speaker and the first right front speaker are disposed at substantially orthogonal directions.

In a preferred embodiment, the plurality of speakers are arranged in a plurality of vertical levels at different height, including a first level that includes a left surround sound speaker and a right surround sound speaker facing substantially opposing to each other, a second level that includes a first left front speaker and a first right front speaker facing substantially opposing to each other, a third level that includes a center speaker facing substantially orthogonal to the first left front speaker, the first right front speaker, the left surround speaker, and the right surround sound speaker, and a fourth level that includes a subwoofer. The plurality of vertical levels may further include a fifth level that includes a second right front speaker, wherein the second right front speaker and the first right front speaker receive audio signals from the same channel. In one embodiment, the plurality of vertical levels further include a sixth level that includes a second left front speaker, wherein the second left front speaker and the first left front speaker receive audio signals from the same channel.

In a preferred embodiment, the one or more audio signal sources comprise a portable media player removably coupled to the housing. The housing may have a slanted top surface having one or more docking stations thereon, and wherein the portable media player is removably docked to one of the docking stations. The one or more audio signal sources may further include a fixed media player embedded substantially within the housing.

In a preferred embodiment, the plurality of speakers are fixedly coupled to the housing. The system may further include an antenna for receiving radio signals. The antenna may be elongated substantially along the vertically elongated housing.

Preferably the system further includes at least one microphone input and a Karaoke mixer. The plurality of speakers may be configured into a 5.1 system.

The system may further include a cooling unit including a plurality of air channels arranged substantially vertically along the housing, thereby allowing cooling of the system through air convection.

In another aspect, the present invention provides a surround sound system, including a vertically elongated housing with a height-to-width ratio in the range of 4 to 6, a plurality of speakers arranged substantially vertically inside the housing, and one or more audio signal sources for outputting audio signals in multiple channels to the plurality of speakers. In a preferred embodiment, the system is configured as part of a home entertainment system in connection with at least a partial reflective environment having one or more reflective surfaces, and wherein the one or more reflective surfaces reflect sound waves from a substantial portion of sound from at least one of the plurality of speakers before the substantial portion of sound reaches a listening position in the home entertainment system. In one embodiment, the at least one reflective surfaces may include a wall of a room. In another embodiment, the at least one reflective surfaces include at least one reflective panels disposed in a room.

In one embodiment, further comprising an elongated antenna for receiving radio signals, wherein the elongated antenna is disposed substantially along the vertically elongated housing.

In another embodiment, the system further includes a cooling unit including a plurality of air channels arranged substantially vertically along the housing, thereby allowing cooling of the system through air convection.

In a preferred embodiment, the system further includes a portable media player removably coupled to the housing.

In another aspect, the present invention provides a method for generating a surround sound in connection with at least a partial reflective environment, including providing an elongated enclosure, providing a plurality of speakers, arranging the plurality of speakers substantially vertically in the elongated enclosure, making electrical connections within the elongated enclosure, and positioning the elongated enclosure with a front surface substantially toward a listening position and with at least two speakers pointing substantially toward two respective partial reflective surfaces of the partial reflective environment.

In a preferred embodiment, arranging the plurality of speakers includes arranging the plurality of speakers in at least four levels, each level having at least one speaker.

In one embodiment, the method further includes docking a portable media player to a docking station on the elongated enclosure.

In another embodiment, the system further includes disposing a reflective panel in the partial reflective environment to adjust the sound wave reflection.

In summary, embodiments of the invention provide a surround sound system including a vertically elongated housing, a plurality of speakers arranged substantially vertically inside the housing, and one or more audio signal sources for outputting audio signals in multiple channels to the plurality of speakers. The multiple channels and speakers can be configured as a 5.1 system. The one or more audio signal sources may include a fixed media player embedded substantially within the housing, and a portable media player removably docked to the housing. A radio signal tuner and antenna are also included in the surround sound system and enclosed in the housing. The surround sound system may further include a Karaoke mixer and be used as a Karaoke performance machine.

The invention, now having been briefly summarized, may be better appreciated by the following detailed description.

### BRIEF DESCRIPTION OF THE DRAWINGS

FIG. 1 is a top plan view of a conventional surround sound system in a user's room;

FIG. 2 is a side view of the conventional surround sound system of FIG. 1 and the sound field distribution produced thereof in a home theatre system;

FIG. 3 is a front plan view of a surround sound system in accordance with an embodiment of the invention;

FIG. 4 is a top plan view of the surround sound system of FIG. 3 and the sound field distribution produced thereof in a user's room;

FIG. 5 is side view of the surround sound system of FIG. 3 in a home theatre system;

FIG. 6 is a diagram illustrating sound wave propagation from various speakers of the surround sound system of FIG. 3;

FIG. 7 is a diagram illustrating a preferred method of assembly and installing the surround sound system according to embodiments of the invention;

FIG. 8 is a perspective view of a surround sound system in accordance with a preferred embodiment of the invention;

FIG. 9 is a back plan view of the surround sound system;

FIG. 10 is a block diagram illustrating the internal structure of the surround system in accordance with an embodiment of the invention when viewed from the back; and

FIG. 11 is a diagram illustrating a user operating the surround sound system in a home network.

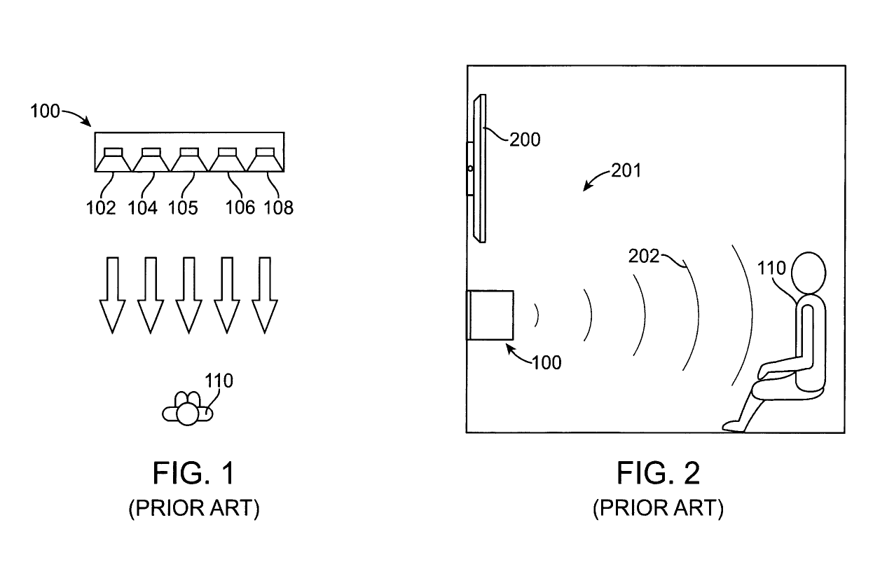

### DETAILED DESCRIPTION OF THE PREFERRED EMBODIMENTS

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

The surround sound system in accordance with a preferred embodiment of the invention serves as a surround sound output device for internal as well as external audio sources including televisions, DVD players, mp3 players etc. The system can work as a standalone, self-contained unit and does not require external sources to function as a media player. The unit is also capable of outputting audio and video signals to television inputs, recording devices, receivers, etc. At least five speakers are enclosed within a single tower enclosure of the unit, including two left channel speakers, two right channel speakers, and a center channel speaker. A subwoofer may also be substantially enclosed in the single enclosure. In addition, a connection port may be provided for connecting an external, larger, subwoofer and making the unit a 5.1 system. Thus, the surround sound system in accordance with embodiments of the invention can be configured as a 5.1 system. Preferably, more speakers, e.g., eight (8) in total, including a subwoofer, are included in the single enclosure.

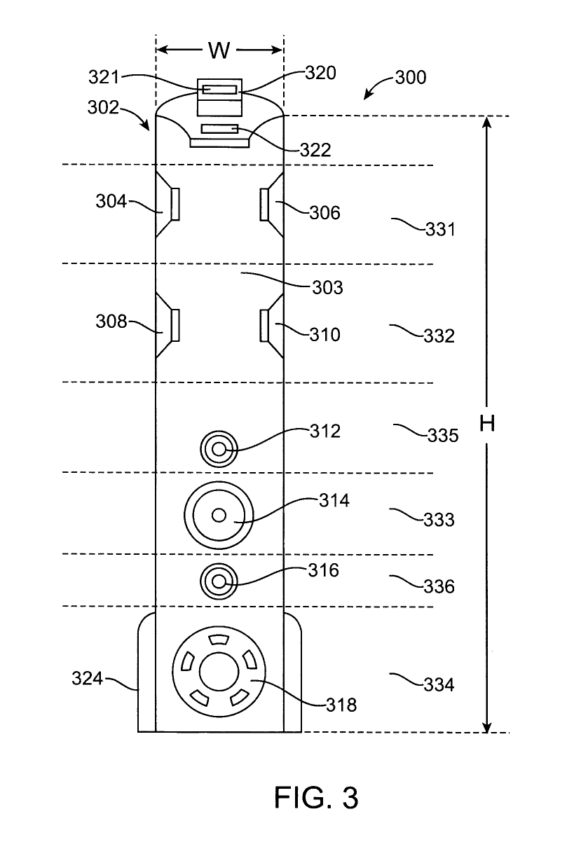

Referring to FIG. 3, a preferred embodiment of the surround sound system 300 comprises a single enclosure or housing 302 having a front surface 303. The enclosure 302 is configured substantially vertically and is referred to as a tower enclosure. The vertically elongated enclosure 302 has an aspect ratio, e.g., the ratio between the height H and the width W, preferably in the range of 2 to 10. Preferably, the H/W ratio is in the range of 4 to 6. As shown in the drawings, the ratio H/W is about 5. A plurality of audio output sources, e.g., speakers, are also arranged substantially vertically, e.g., stacked, in the tower enclosure 302. As shown, the plurality of speakers include a left surround speaker 304, a right surround speaker 306, a first left front speaker 308, a first right front speaker 310, a second right front speaker 312, a center speaker 314, a second left front speaker 316, and a subwoofer 318.

The second right front speaker 312 receives audio input from the same channel as the first right front speaker 310. Although the system 300 does not necessarily include the second right front speaker 312, in accordance with the preferred embodiment, the second front speaker 312 is included and is pointing substantially toward the listener or listening position. It is found from experimental studies that inclusion of the second right front speaker 312 improves the overall sound quality as compared with when only the first right front speaker 310, which points substantially toward the right side, is included. In addition, although the second right front speaker 312 as shown is smaller in size as compared with the first right front speaker 310, those of ordinary skill in the art will recognize that the second right front speaker 312 may be of equal size with, or larger than, the first right front speaker 310. Similarly, a second left front speaker 316 is included to complement the first left front speaker 308. It is noted that the words “right” and “left” designate directions in the drawings for convenience only and are not limiting.

The plurality of speakers as shown are arranged in a plurality of vertical levels at different height. For example, a first level 331 includes the left surround speaker 304 and the right surround speaker 306 facing substantially opposing to each other. A second level 332 includes the first left front speaker 308 and the first right front speaker 310 facing substantially opposing to each other. A third level 333 includes the center speaker 314 facing substantially orthogonal to the first left front speaker 308, the first right front speaker 310, the left surround speaker 304, and the right surround sound speaker 306. A fourth level 334 includes the subwoofer 318. In addition, a reflector 324 may be disposed adjacent the subwoofer 318 for reflecting low-frequency sound waves toward the listener. The reflector 324 may be integrally formed with the tower enclosure 302, and may also acts as a pedestal to helps stabilize the system 300 as the reflector 324 effectively increases the bottom surface area of the tower enclosure 302.

The plurality of vertical levels may further include a fifth level 335 including the second right front speaker 312. As shown the second right front speaker 312 and the first right front speaker 310 face substantially orthogonal to each other although they receive audio signals from the same channel. A sixth level 336 may be included, which includes the second left front speaker 316. The second left front speaker 316 and the first left front speaker 308 face substantially orthogonal to each other while receiving audio signals from the same channel. Those of ordinary skill in the art will recognize that, the second right front speaker 312 is not necessarily disposed above the center speaker 314 and the second left front speaker 316. Other arrangements are possible. For example, the second right front speaker 312 and the second left front speaker 316 may be arranged within one level.

As discussed in more detail below, the surround sound system 300 allows a portable media player 320, such as an MP3 player or an iPod, to dock into the system 300 and become one of the audio signal sources. In addition, fixed, internal media players 322, such as CD or DVD players, may be integrally part of the surround sound system 300.

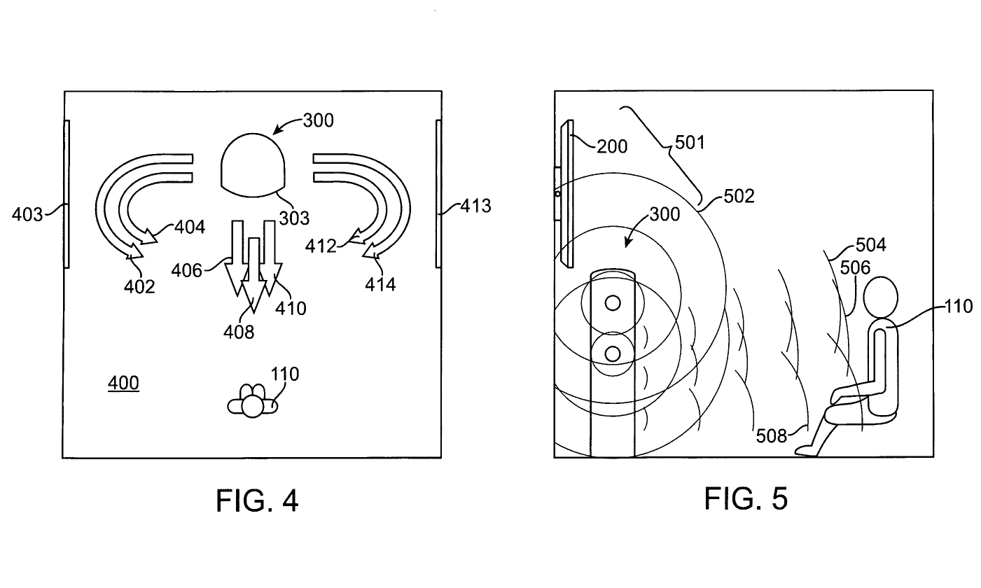

Sound wave propagation from the surround sound system 300 to the listener or listening position 110 is illustrated as block arrows in FIG. 4. As shown, the sound system 300 is placed in a room 400, and the listener 110 preferably faces the front surface 303 of the sound system 300. A large portion of the left surround sound wave 402 originating from the left surround sound speaker 304 is reflected by a first surface or wall 403 of the room 400, and then is received by the listener 110. Similarly, the front left sound wave 404 is also bounced off the wall 403 before being received by the listener 110. By contrast, front left sound wave 406 originating from the second left front speaker 316, center sound wave 408 originating from the center speaker 314, and front right sound wave 410 originating from the second right front speaker 312, are received more directly by the listener 110. Front right sound wave 412 originating from the first right front speaker 310, and right surround sound wave 414 originating from the right surround speaker 306, are bounced off from a wall or surface 413 of the room 400 before being received by the listener 110.

In addition to the horizontally distributed sound waves as illustrated in FIG. 4, the sound system 300 also provides a vertical distribution of sound waves in a height dimension, thereby providing a feel of vertical depth to the listener 110, as illustrated in FIG. 5. As shown, the sound system 300 is preferably disposed beneath a display or screen 200 if the display 200 is placed at a sufficient height. The height of the sound system 300 is preferably similar to that of the listener 110 when seated. The sound system 300 and the display or screen 200 may be part of a home theatre system or entertainment center 501. The display 200 may be, for example, a TV or a projector. The sound system 300 may alternatively be placed on a side of the display 200. The sound system 300 provides a plurality of vertically distributed sound waves, shown as wave fronts 502, 504, 506, toward the listener 110. Thus, the listener feels a three-dimensional (3-D) field of sound including the height dimension that cannot be easily realized in the conventional system 100 shown in FIG. 2.

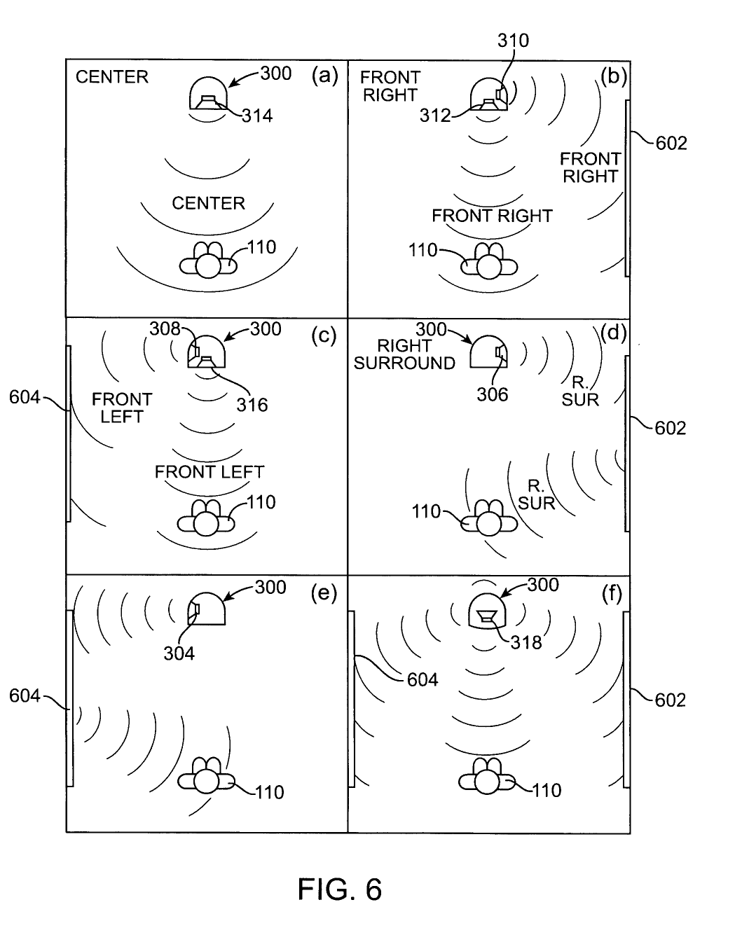

FIG. 6 provides more details about the sound waves from various speakers of the sound system 300. In panel (a), it is shown that the center speaker 314 substantially faces the listener or listening position 110, and the listener receives the sound wave directly from the center speaker 314. In panel (b), it is shown that the first right front speaker 310 emits sound waves that are bounced off a wall or surface 602 before being received by the listener 110. The second right front speaker 312 emits sound waves directly toward the listener 110 and receives audio input from the same channel as the first right front speaker 310. In panel (c), it is shown that the first left front speaker 308 emits sound waves that are bounced off a wall or surface 604 before being received by the listener 110. The second left front speaker 316 complements the sound waves from the first left front speaker 308, and receives the input audio data from the same channel as the first left front speaker 308. In panel (d), it is shown that the right surround speaker 306 emits sound waves that are also reflected by the wall 602 before being received by the listener 110. In panel (e), it is shown that the left surround speaker 304 emits sound waves that are reflected by the wall 604 before being received by the listener 110. In panel (f), it is shown that the subwoofer 318, which as shown faces away from the listener 110, emits low-frequency sound waves in various directions, part of which are reflected by the walls 602, 604 before being received by the listener 110.

Although two walls or surfaces 602, 604 are illustrated in FIG. 6, they are merely suggestive of examples of at least partially reflective surface areas in a room. Such at least partially reflective surface areas may include, for example, side walls, ceilings, floors, and back walls. Other reflective, or in some cases absorptive, surfaces or regions may become part of the home theatre system. Such surfaces or regions may include, for example, furniture or fixtures within the room, and intentionally placed sound reflection/absorption panels. All these structures may affect the sound field originated from the surround sound system 300.

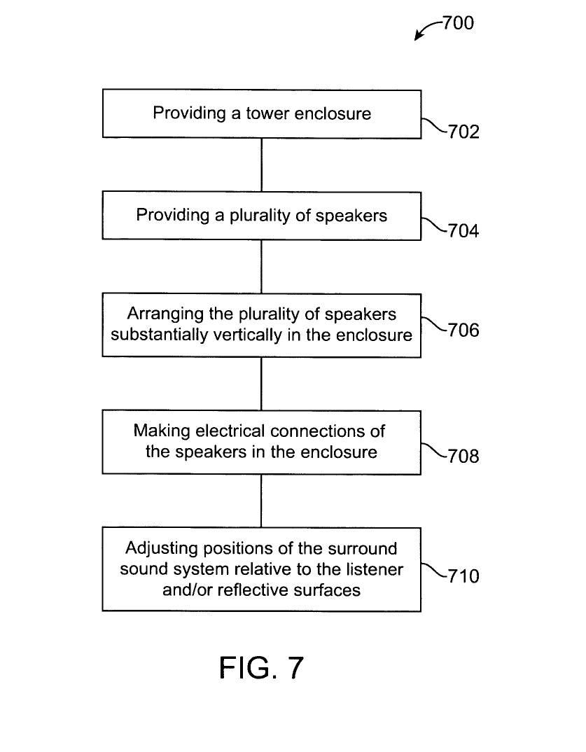

A preferred method 700 of assembling and installing the surround sound system according to an embodiment of the invention is summarized in the flowchart in FIG. 7. In step 702, a tower enclosure is provided. In step 704, a plurality of speakers are provided. In step 706, the plurality of speakers are arranged, or stacked, substantially vertically in the tower enclosure. In step 708, electrical connections between the speakers, audio signal sources, and drive circuits are made. In step 710, position relative to the listener or listening position, such as left or right, and height, may be adjusted in the home theatre system. The position of the all-in-one surround sound system relative to reflective surfaces in the room may also be taken into account.

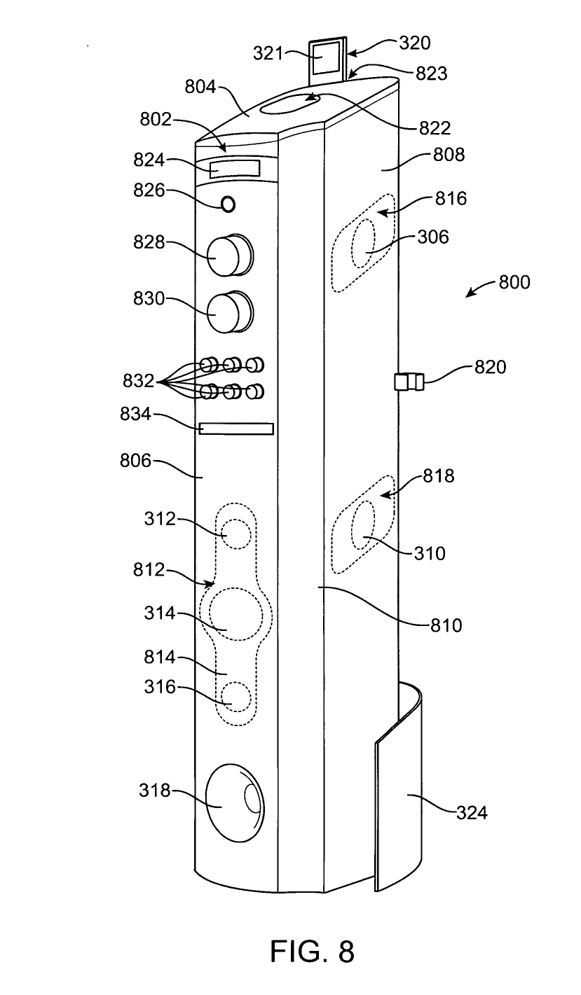

FIG. 8 is a perspective view of a surround sound system 800 in accordance with a preferred embodiment of the invention. As shown, the single enclosure or housing 802 has a multiply segmented surface including a top surface 804. The top surface 804 as shown is slanted, allowing the user to access certain features of the surround sound system 800, as discussed in further detail below.

The single tower enclosure or housing 802 also includes a front surface 806, a pair of side surfaces 808, and a plurality curved round-up surfaces 810. The curved round-up surfaces 810 avoid sharp corners while substantially preserving the internal geometrical volume of the tower enclosure 802.

The front surface 806 has a front window 812, which as shown is covered with a speaker grill cover 814 to allow sound waves to emanate therethrough. The grill cover 814 is preferably made of mesh or porous material, and may be removably mounted to the housing 802. As shown, the second right front speaker 312, the center speaker 314, and the second left front speaker 316 are partially visible in the window 812 behind the grill cover 814. The right side surface 808 has two right side windows 816, 818, for the right surround speaker 306 and the first right front speaker 310, respectively. The housing 802 is substantially symmetrical from left to right. Thus, the left surface is not further illustrated.

The housing 802 may further comprise one or more clips or holders 820 for removably securing the microphones to the housing 802.

The slanted top surface 804 includes one or more top windows 822, in which a user interface may be included for the user to interact with one or more of the audio signal sources. Lighting may also be provided from the window to illuminate, for example, a ceiling, or to project images synchronizing with the music to the ceiling. The top surface 804 also provides one or more slots and/or docking stations 823 to receive external audio signal sources such as digital media or portable medium players. For digital media such as a flash memory card inserted into the slots on the top surface 804, the surround sound system 800 itself acts as a medium player. Accordingly, the surround sound system 800 may include corresponding driver and decoder circuitry.

As shown, a portable medium player 320, such as an MP3 player or iPod, is docked in the docking station 823. In this case, the audio signals output from the portable medium player 320 are directly fed into the surround sound system 800. The portable medium player 320 itself has a display 321, separate from a main display 824 that is integrally part of the sound system 800 shown on the front surface 806. The display 321 of the portable medium player 320, and/or the main display 824 may be used to indicate, for example, the programs of choice, and other settings. The display 321 may be a touch screen, allowing user input from the display 321 directly.

An on/off 826 is on the frontal surface of the housing 802. The on/off button 826 may also include an indicator, which may comprise a light emitting diode (LED) for indicates a power status of the sound system 800. A pair of large knobs 828, 830 are used, for example, to tune the volume, and/or the radio signal channels when AM/FM/XM radio features are included. A plurality of small knobs 832 are used to adjust, for example, individual sound channels. A fixed media player 834 is integrally built into the surround sound system 800. The fixed media player 834 may be a DVD player/recorder, a Blu-ray Disc player, an HD DVD player, a CD player/recorder, a CD read only memory (ROM) player, a flash memory device, a tape player/recorder, etc. The CD and DVD media may have content stored thereon such as standard sound track, video, or mp3 files. The media may also be in the format of, for example, CDG, VCD, Photo-CD, CD-R, CD-RW, DVD, Blu-ray Disc, HD DVD, etc. In particular, the fixed media player 834 can play Karaoke graphic discs to enable Karaoke features of the surround sound system 800. The fixed media player 834 may also comprise other memory devices capable of storing multimedia data such as music, video, and the like.

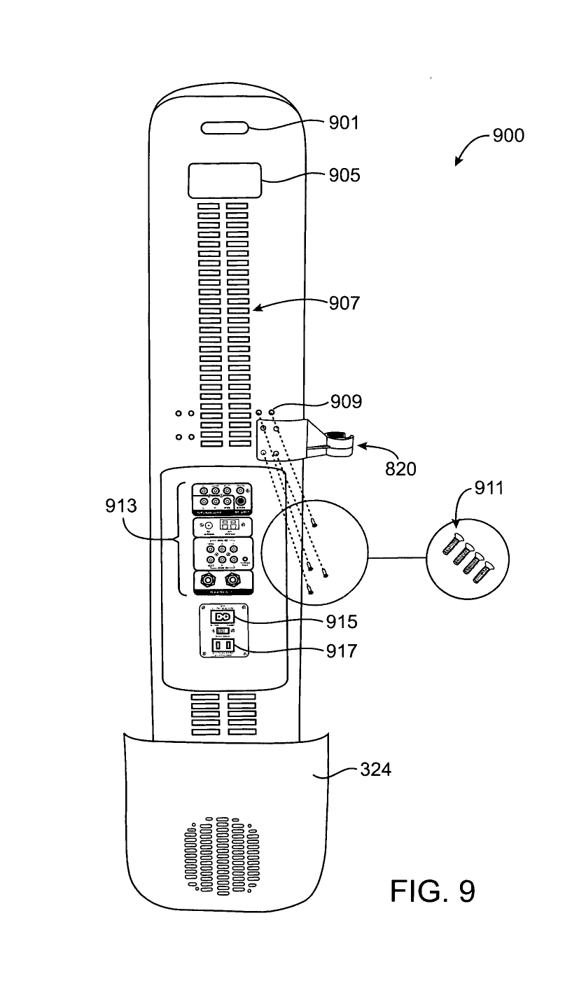

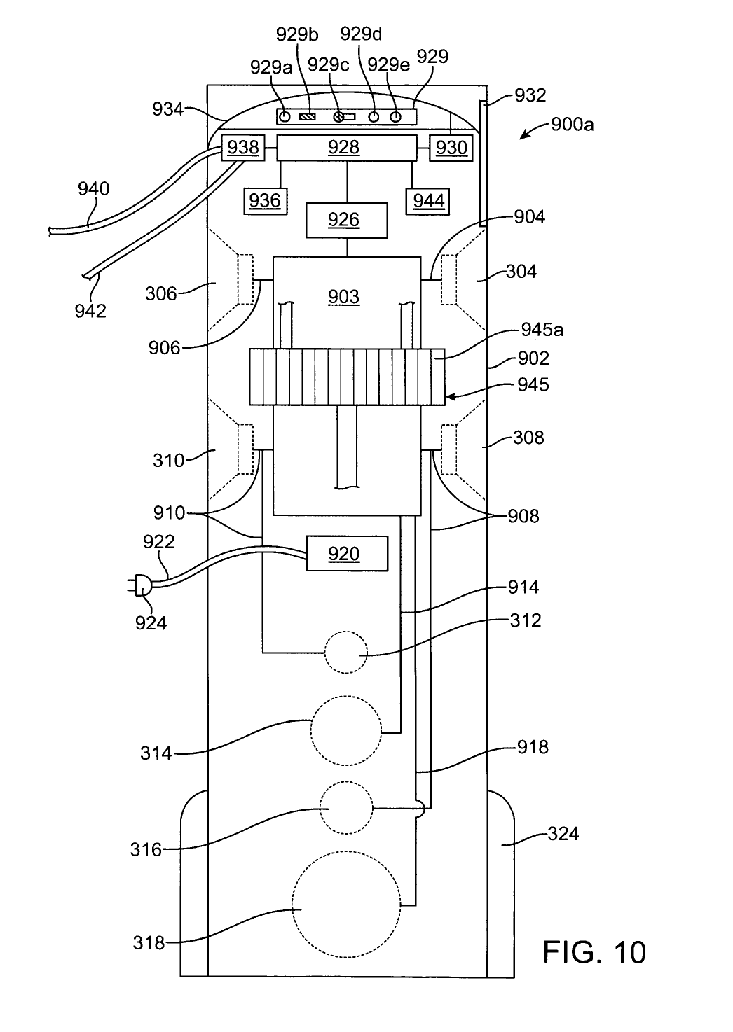

FIG. 9 is a back plan view of a surround sound system 900 in accordance with an embodiment of the invention. The back surface of the system 900 may include a charger slot 901, which is used for a power cord of the portable medium player 320 to extend therethrough such that the portable medium player 320 may use a separate power supply. This is useful when the portable medium player 320 is not electrically compatible with the docking station 823. In this case an output jack such as a standard 1/8 inch output jack (not shown) is also used to output the audio signal from the portable medium player 320 to the surround sound system 900. If on the other hand the portable medium player 320 is electrically compatible with the docking station 823, the portable medium player 320 may draw electrical power directly from the surround sound system 900.

A handle 905 may be included, thus making the surround sound system 900 a portable system. The slim tower design allows the system 900 to be easily moved around using one hand. A plurality of cooling windows 907 are spread throughout the back surface and the reflector 324. A cooling fan (not shown) may be used to aid air circulation. As discussed in detail below, the tower design of the surround sound system 900 advantageously improves the cooling.

A plurality of holes 909 are used to receive screws 911, thereby securing the holder 820 to the surround sound system 900. A plurality of input/output terminals 913 are included. These terminals 913 may include, but are not limited to, component (Y, Cb/Pb, Cr/Pr) video output jacks for connection to a TV with component video inputs, digital coaxial terminals for connection to a receiver/mixer with a digital coaxial input, S-video output jack for connection to a TV with an S-video input, mixed A/V RCA outputs for connection to a TV with RCA audio inputs and a RCA video input, AM/FM antenna jacks for connection to external antennas if such external antennas are desired, RCA input channels for connection to external RCA audio/video devices, headphone output jack, and microphone inputs. The terminals 913 allow the surround sound system 900 to be more flexibly connected to other devices and integrated into a larger system. For example, if the fixed media player 834 comprises a conventional DVD player, while the user desires to have a Blu-ray Disc or HD DVD, or any other media, played, the user can easily plug in an external medium player, such as a Blu-ray Disc player or an HD DVD player, using one of the terminals 913.

Power cord input 915 is used for connection to a power cord which in turn is plugged into a power socket. A power outlet 917 is provided to power auxiliary devices such as the portable medium player 320.

FIG. 10 is a block diagram illustrating an internal structure of a surround sound system 900a in accordance with an embodiment of the invention, when viewed from the back. As shown, an amplifier 903 outputs audio signals to the speakers. More specifically, the left surround speaker 304 receives the left surround channel 904 from the amplifier 903, and the right surround speaker 306 receives the right surround channel 906. The first left front speaker 308 and the second left front speaker 316 both receive the left front channel 908, and the first right front speaker 310 and the second right front speaker 312 both receive the right front channel 910. The center speaker 314 receives the center channel 914, and the subwoofer 318 receives the subwoofer channel 918. Thus, the surround sound system 900a as shown is configured as a 5.1 system, which includes five full-range channels (i.e., left surround, right surround, center, right front, and left front) and the low-frequency, subwoofer channel. It is noted that although the subwoofer 318 as shown is only coupled to the subwoofer channel 918, the subwoofer 318 may be configured to output low-frequency components from all channels. This allows smaller speakers to be used in the system, as the smaller speakers otherwise do not played back well the low-frequency components.

In accordance with the embodiment of the invention as shown, when the first left front speaker 308 and the second left front speaker 316 are both coupled to the left front channel 908 as shown, the sound quality of the left front channel as perceived by the listener is improved as compared with when only one left front speaker is used. Similarly, the second right front speaker 312 improves the perceived sound quality of the right front channel. Alternatively, the additional speakers 312, 316 may be connected to other channels, such as channels beyond the 5.1 channels when more sophisticated channel systems are used.

The surround sound system 900a further comprises a power unit 920. The power unit may be coupled to a power cable 922 and a wall plug 924. Preferably, the output power is on the order of 200 watts. Alternatively, the power unit may include a rechargeable battery for complete standalone operations.

The amplifier 903 may receive signals from a digital signal processor (DSP) 926, which may in turn receive signals from a signal interface 928. A signal interface panel 929 corresponding to the signal interface 928 may be mounded on the back surface of the housing 902. The signal interface panel 929 may include a number of digital data terminals 929a-929e such as an IEEE 1394 terminal, a USB terminal, and an analog input/output terminal such as an S terminal. Thus, the system 900a is also capable of receiving output from external auxiliary sources using, for example, RCA, digital coaxial, ¼″ microphone and ⅛″ audio jack inputs.

The signal interface 928 may also be coupled to an internal tuner 930 for receiving/tuning, for example, AM/FM, and satellite (such as XM) radio signals. The tuner 930 in turn is coupled to one or more antennas 932, 934. As shown, the antenna 932 is elongated and substantially straight, and may be installed in a corner of the housing 902. Advantageously, the elongated antenna 932 is substantially enclosed in the vertically elongated housing 902 without extruding from the sound system 900a. The position of the elongated antenna 932 also takes advantage of the height of the housing 902 for a better signal reception over the air. The housing 902, or at least of portion thereof, may be made of materials to allow electromagnetic waves to transmit therethrough. Such materials may include, for example, plastic or other materials known in the art. An arched antenna 934 may also be included in the system 900a.

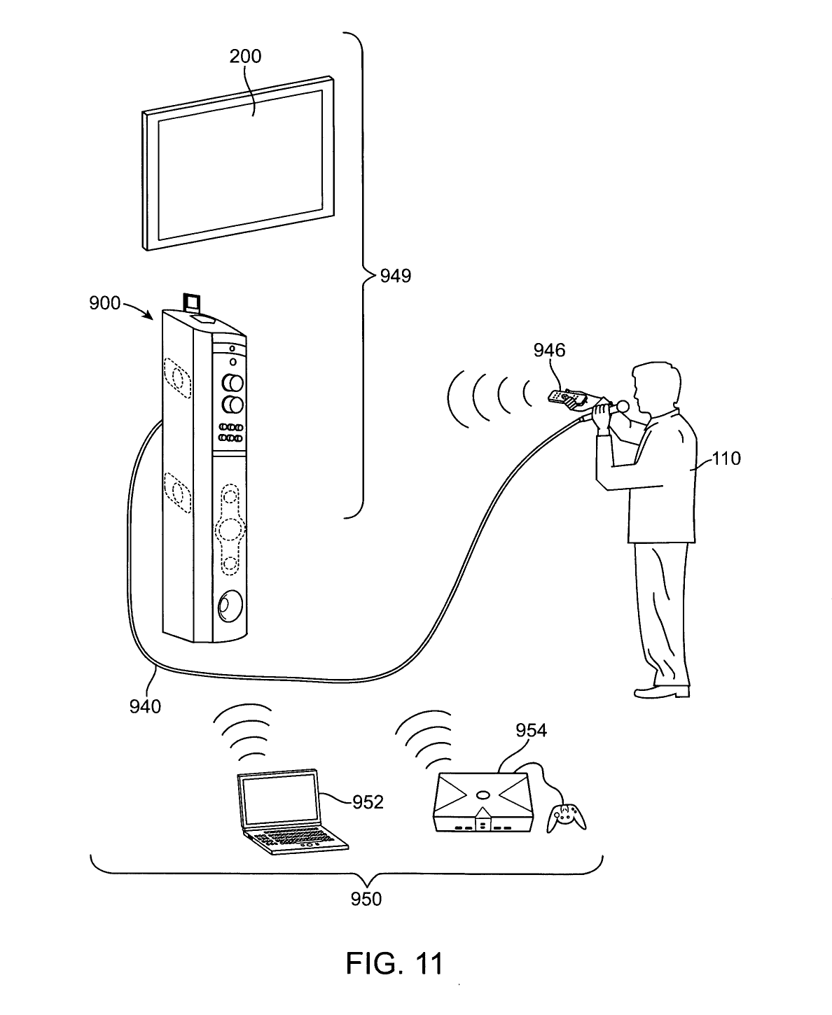

The signal interface 928 may also be coupled to, for example, the docking station 823 to receive the portable medium player 320 as shown in FIG. 8. In addition, the signal interface 928 may include means to receive media such as flash memory, including USB drive, memory card or stick, and hard drive. The system 900a may also include internal storage units 936 such as memory or a hard drive. Additionally, the interface 928 may be coupled to an audio signal input unit 938 capable of acting as a Karaoke mixer, allowing the unit to serve as a Karaoke performance machine. The audio signal input unit 938 may include one or more internal microphones. Individual microphone volume control and Karaoke-specific audio controls such as mixing, effect control and pitch control can be adjusted through one or more of the knobs 828, 830, 832 on the front surface 806, or through a wireless remote control device (FIG. 11). In addition, one or more jacks, such as standard ¼″ microphone inputs, may be included to allow external microphones connected by cables 940, 942 to plug into the system 900a.

Further, the system 900a may include a communication module 944 to communicate wirelessly with a remote control, wireless microphones, or a home network. The wireless communication means may include, for example, infrared, radio frequency (RF), IEEE 1394 wireless interface, Bluetooth, etc.

The system 900a may include a cooling unit 945. The cooling unit 945 may utilize air or liquid cooling. In a preferred embodiment, the cooling unit 945 comprises a plurality of air channels 945a arranged substantially vertically along the elongated housing 902. Airflow may be established in the air channels 945a as at least partially driven by the heat, and exit from the top portion of the housing 902. Thus, the tower design of the system 900a may be in the advantage of cooling the system 900a, as the tower effectively acts as a chimney resulting in cooling through air convection, thereby reducing the power consumption and noise associated with the cooling unit 945.

FIG. 11 is a diagram illustrating a user 110 operating the surround sound system 900. As shown, the user 110 may control the surround sound system 900 using a wireless remote control device 946. The user 110 as shown is holding an external microphone 948, which is coupled to the surround sound system 900 via the cable 940. Thus, the user can enjoy the Karaoke features of the surround system 900. Although a wired configuration is shown, wireless microphones may be used thereby removing the need for the cable 940. The screen or display 200 and the surround sound system are part of the home theatre system or entertainment center 949. The surround sound system 900 may be coupled to the screen or display 200 via, for example, standard RCA style audiovisual cables. Alternatively, the screen or display 200 may be in communication with the surround sound system 900 wirelessly. The home theatre system 949 may further be part of a home network 950, which may include, for example, one or more personal computers 952, which may be communicating with the surround sound system 900 via wired or wireless means, and a game console or play station 954 that allows the user to enjoy surround sound associated with games. The audio content stored in the computer 952 can thus be directly played from the surround sound system 900.

In summary, the surround sound system according to embodiments of the invention includes many integral or embedded features that would otherwise require many separate devices. For example, by placing the radio signal receiver, media player and surround sound speaker system into one unit, the system is slim, takes little space, and is aesthetically appealing. Because the surround sound system is integrally formed, and the speakers are fixedly coupled to, and substantially within, a single tower enclosure, there is no need for the user to install the speakers separately, hook up and route various wires, or to mount and adjust positions of various individual devices. Thus, the system can be a plug and play entertainment center. The speaker cable is no longer needed, thereby reducing the cost and cumbersome management of the speaker cables. The cable loss is reduced. By placing the surround sound system in an optimal location in a room and connecting other home network devices to corresponding inputs, the speakers housed in the unit will simulate a traditional surround sound system by reflecting sound off of the surrounding reflective walls. The multi-channel sound reproduction is improved through the improved speaker arrangement. In addition to the reduced cost and saved room, the internal antenna also takes advantage of the tower design of the surround sound system for a better signal reception, and the cooling of the surround system is also improved as a result of the tower design.

It is to be expressly understood that although some embodiments of the surround sound system according to the invention have been described above with reference to the drawings, the surround sound systems may have other embodiments to be adapted to other configurations. The surround sound systems may be used for rendering surround sound from many different types of sources such as tapes, CDs, DVDs, flash memory devices, and such sources may be integrally part of the surround sound system, or may be coupled to the surround sound system wirelessly or through wires. In addition, the surround sound system can be used to advantage in any of the applications for enhanced sound effect. For example, the surround sound system 900 may be configured to be installed in a vehicle. Accordingly, the orientation of the surround sound system may be adjusted, for example, to face substantially toward the driver of the vehicle. In addition, the channel configuration may be changed so that the driver perceives the sound directions as intended. The reflection from the inner surfaces of the vehicle is also taken into account. The relatively large number of speakers in the surround sound system 800 provides the flexibility of configuring the channels/speakers according to different applications/environments.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different elements, which are disclosed above even when not initially claimed in such combinations.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what incorporates the essential idea of the invention.

What is claimed is:

1. A surround sound system, comprising:
a vertically elongated housing;
a plurality of speakers arranged substantially vertically inside the housing; and
one or more audio signal sources for outputting audio signals in multiple channels to the plurality of speakers.

2. The system of claim 1, wherein the vertically elongated housing has a ratio between its height and width in the range of 2 to 10.

3. The system of claim 2, wherein the ratio is in the range of 4 to 6.

4. The system of claim 1, wherein the plurality of speakers include:
a left surround speaker;
a right surround speaker;
a first left front speaker;
a first right front speaker;
a center speaker; and
a subwoofer.

5. The system of claim 4, further comprising a second left front speaker, wherein the second left front speaker and the first left front speaker receive audio signals from the same channel, and wherein the second left front speaker and the first left front speaker are disposed at substantially orthogonal directions.

6. The system of claim 5, further comprising a second right front speaker, wherein the second right front speaker and the first right front speaker receive audio signals from the same channel, and wherein the second right front speaker and the first right front speaker are disposed at substantially orthogonal directions.

7. The system of claim 1, wherein the plurality of speakers are arranged in a plurality of vertical levels at different height, including a first level that includes a left surround sound speaker and a right surround sound speaker facing substantially opposing to each other, a second level that includes a first left front speaker and a first right front speaker facing substantially opposing to each other, a third level that includes a center speaker facing substantially orthogonal to the first left front speaker, the first right front speaker, the left surround speaker, and the right surround sound speaker, and a fourth level that includes a subwoofer.

8. The system of claim 7, wherein the plurality of vertical levels further include a fifth level that includes a second right front speaker, wherein the second right front speaker and the first right front speaker receive audio signals from the same channel.

9. The system of claim 8, wherein the plurality of vertical levels further include a sixth level that includes a second left front speaker, wherein the second left front speaker and the first left front speaker receive audio signals from the same channel.

10. The system of claim 1, wherein the one or more audio signal sources comprise a portable media player removably coupled to the housing.

11. The system of claim 10, wherein the housing comprises a slanted top surface having one or more docking stations thereon, and wherein the portable media player is removably docked to one of the docking stations.

12. The system of claim 10, wherein the one or more audio signal sources further comprise a fixed media player embedded substantially within the housing.

13. The system of claim 1, wherein the plurality of speakers are fixedly coupled to the housing.

14. The system of claim 1, further comprising an antenna for receiving radio signals.

15. The system of claim 14, wherein the antenna is elongated substantially along the vertically elongated housing.

16. The system of claim 1, further comprising at least one microphone input and a Karaoke mixer.

17. The system of claim 1, wherein the plurality of speakers are configured into a 5.1 system.

18. The system of claim 1, further comprising a cooling unit including a plurality of air channels arranged substantially vertically along the housing, thereby allowing cooling of the system through air convection.

19. A surround sound system, comprising:
a vertically elongated housing with a height-to-width ratio in the range of 4 to 6;
a plurality of speakers arranged substantially vertically inside the housing; and
one or more audio signal sources for outputting audio signals in multiple channels to the plurality of speakers.

20. The system of claim 19, wherein the system is configured as part of a home entertainment system in connection with at least a partial reflective environment having one or more reflective surfaces, and wherein the one or more reflective surfaces reflect sound waves from a substantial portion of sound from at least one of the plurality of speakers before the substantial portion of sound reaches a listening position in the home entertainment system.

21. The system of claim 20, wherein the at least one reflective surfaces comprise a wall of a room.

22. The system of claim 20, wherein the at least one reflective surfaces comprise at least one reflective panels disposed in a room.

23. The system of claim 20, further comprising an elongated antenna for receiving radio signals, wherein the elongated antenna is disposed substantially along the vertically elongated housing.

24. The system of claim 20, further comprising a cooling unit including a plurality of air channels arranged substantially vertically along the housing, thereby allowing cooling of the system through air convection.

25. The system of claim 20, further comprising a portable media player removably coupled to the housing.

26. A method for generating a surround sound in connection with at least a partial reflective environment, comprising:
providing an elongated enclosure;
providing a plurality of speakers;
arranging the plurality of speakers substantially vertically in the elongated enclosure;
making electrical connections within the elongated enclosure; and
positioning the elongated enclosure with a front surface substantially toward a listening position and with at least two speakers pointing substantially toward two respective partial reflective surfaces of the partial reflective environment.

27. The method of claim 26, wherein arranging the plurality of speakers comprises arranging the plurality of speakers in at least four levels, each level having at least one speaker.

28. The method of claim 26, further comprising docking a portable media player to a docking station on the elongated enclosure.

29. The method of claim 26, further comprising disposing a reflective panel in the partial reflective environment to adjust the sound wave reflection.
